(19) United States
(12) Patent Application Publication
(10) Pub. No.: US 2026/0170114 A1
(43) Pub. Date: Jun. 18, 2026

(54) VISUAL FRAUD DETECTION AND EVIDENCE COLLECTION DURING LIVE IMAGE VERIFICATION

(71) Applicant: Capital One Services, LLC, McLean, VA (US)

(72) Inventors: Joanna WEBER, Glen Allen, VA (US); Joshua CROW, Richmond, VA (US)

(21) Appl. No.: 18/986,411

(22) Filed: Dec. 18, 2024

(51) Int. Cl. G06F 21/32; G06V 40/40

(52) U.S. Cl. CPC G06F 21/32; G06V 40/40

(57) ABSTRACT

A system is provided for enhanced user authentication using image fraud detection during a liveness verification for determining access for a user account. The system may detect an authentication event associated with an access attempt for the user account; obtain a live user image associated with the authentication event based on detecting the authentication event, the live user image being a live image of an access requester; analyze, using a fraud detection machine learning model, the live user image for one or more fraudulent image parameters; execute, using the fraud detection machine learning model, a liveness challenge based on detecting the one or more fraudulent image parameters to determine whether or not fraudulent activity associated with the authentication event is present; and authenticate the access attempt based on the fraudulent activity not being present; or deny the access attempt based on the fraudulent activity being present.

### BACKGROUND

An authentication process may be performed for various purposes. For example, if a user attempts to gain access to an account associated with the user, the authentication process may be performed to verify an identity of the user to enable the user to access the account.

### SUMMARY

In some implementations, a system for enhanced user authentication using image fraud detection during a liveness verification for determining access for a user account includes one or more memories; and one or more processors, communicatively coupled to the one or more memories, configured to: detect an authentication event associated with an access attempt for the user account, the access attempt being initiated by an access requester; obtain a live user image associated with the authentication event based on detecting the authentication event, the live user image being a live image of the access requester; analyze, using a fraud detection machine learning model, the live user image for one or more fraudulent image parameters; initiate, using the fraud detection machine learning model, a live identity verification challenge based on detecting the one or more fraudulent image parameters, including generating one or more prompts indicating one or more tasks to be performed by the access requester; execute the live identity verification challenge by prompting the access requester, with the one or more prompts, to perform the one or more tasks; obtain digital evidence of the access requester performing the one or more tasks, wherein the digital evidence includes at least one of live image data, live video data, or live audio data; analyze, using the fraud detection machine learning model, the digital evidence to determine whether or not fraudulent activity associated with the authentication event is present; and authenticate the access attempt based on the fraudulent activity not being present; or deny the access attempt based on the fraudulent activity being present.

In some implementations, a system for enhanced user authentication using image fraud detection during a liveness verification for determining access for a user account includes one or more memories; and one or more processors, communicatively coupled to the one or more memories, configured to: detect an authentication event associated with an access attempt for the user account, the access attempt being initiated by an access requester; obtain a live user image associated with the authentication event based on detecting the authentication event, the live user image being a live image of the access requester; analyze, using a fraud detection machine learning model, the live user image for one or more fraudulent image parameters; execute, using the fraud detection machine learning model, a liveness challenge based on detecting the one or more fraudulent image parameters to determine whether or not fraudulent activity associated with the authentication event is present; and authenticate the access attempt based on the fraudulent activity not being present; or deny the access attempt based on the fraudulent activity being present.

In some implementations, a method for performing image fraud detection during a liveness verification for determining access for a user account includes detecting, by a verification system, an authentication event associated with an access attempt for the user account, the access attempt being initiated by an access requester; obtaining, by the verification system, a live user image associated with the authentication event based on detecting the authentication event, the live user image being a live image of the access requester; analyzing, by the verification system, using a fraud detection machine learning model, the live user image for one or more fraudulent image parameters; initiating, by the verification system, using the fraud detection machine learning model, a live identity verification challenge based on detecting the one or more fraudulent image parameters, including generating one or more prompts indicating one or more tasks to be performed by the access requester; executing, by the verification system, the live identity verification challenge by prompting the access requester, with the one or more prompts, to perform the one or more tasks; obtaining, by the verification system, digital evidence of the access requester performing the one or more tasks, wherein the digital evidence includes at least one of live image data, live video data, or live audio data; analyzing, by the verification system, using the fraud detection machine learning model, the digital evidence to determine whether or not fraudulent activity associated with the authentication event is present; and authenticating, by the verification system, the access attempt based on the fraudulent activity not being present; or denying, by the verification system, the access attempt based on the fraudulent activity being present.

### BRIEF DESCRIPTION OF THE DRAWINGS

FIGS. 1A-1E are diagrams of an example associated with enhanced authentication using image fraud detection during a liveness verification for determining access for a user account, in accordance with some embodiments of the present disclosure.

FIG. 2 is a diagram illustrating an example of training and using a machine learning model in connection with enhanced authentication using image fraud detection during a liveness verification, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with enhanced authentication using image fraud detection during a liveness verification, in accordance with some embodiments of the present disclosure.

FIG. 5 is a flowchart of an example process associated with enhanced authentication using image fraud detection during a liveness verification, in accordance with some embodiments of the present disclosure.

### DETAILED DESCRIPTION

The following detailed description of example implementations refers to the accompanying drawings. The same reference numbers in different drawings may identify the same or similar elements.

Some actions associated with user access may be based on authentication of information associated with an authorized user. An access attempt may be a log-in access attempt, an attempt to access sensitive information, and/or a transactional access attempt (e.g., for initiating a transaction), among other examples. An authentication system may require an access attempt to be authenticated prior to granting access or enabling the access attempt to proceed. For example, a website may use an authentication system to authenticate an identity of the user before granting the user access to the website. Multi-factor authentication (MFA) is an authentication technique in which a device of the user is granted access to a resource (e.g., a computing resource, an application, a transaction, and/or a page associated with an account) only after successfully presenting two or more factors to the authentication system. The two or more factors may include knowledge (e.g., something only the user knows), possession (e.g., something only the user has), and/or inherence (e.g., something only the user is), among other examples.

For example, the authentication system may authenticate an access attempt (e.g., to access a resource) using a user image of the user. The user image may depict a face of the user, which may be referred to as a “selfie.” Liveness testing is a security measure used to ensure that a person attempting to authenticate (e.g., through facial recognition or other biometric methods) is a real, live human and not an image, a video, a mask, or a deepfake (e.g., a filter). Liveness testing may play a crucial role in preventing spoofing attacks where an unauthorized person might try to trick the authentication system by presenting a photograph, pre-recorded video, a filter, or a three-dimensional (3D) model of an authorized person's face. Liveness testing uses a premise of real-time interaction with an access requester in order to verify whether or not the access requester is the authorized user. During the liveness testing, the authentication system may challenge the access requester to provide evidence, by way of one or more inputs, that the access requester is the authorized user. Thus, using liveness testing, the authentication system may verify that the one or more inputs come from a live user interacting in real-time with the authentication system. The authentication system may analyze facial features such as skin texture, skin tone, depth, and a 3D structure of the face to ensure authenticity.

However, attackers use increasingly sophisticated methods such as high-quality 3D masks, video presentations, or even deepfake technology to bypass liveness detection. As a result, the authentication system may consume resources (e.g., computing resources, memory resources, networking resources, and/or other resources) associated with granting the malicious actor access to a resource based on the incorrect authentication determination. For example, the authentication system may consume resources to perform a forensic examination associated with the resource to determine whether the malicious actor caused any adverse effects to the resource. As another example, the authentication system may consume resources to provide notifications associated with the improper access to the resource. Thus, liveness testing must constantly evolve to stay ahead of increasingly sophisticated methods used to bypass liveness detection.

Some implementations described herein provide enhanced user authentication using image fraud detection during a liveness verification for determining access for a user account. In some implementations, an authentication system may use artificial intelligence (AI), such as a machine learning model, to detect possible fraudulent activity (e.g., deepfakes (filters), physical masks, or duress (fraud by force) during a live image verification. The liveness verification may be performed as part of a live user image verification process (e.g., a selfie verification capture) for authenticating an access requester as an authorized user. For example, the authentication system may detect an authentication event associated with an access attempt for the user account, and initiate a liveness testing. In some cases, the liveness testing may be initiated as part of an initial access attempt (e.g., to access an account page or webpage). In some cases, the liveness testing may be initiated as part of a stepped-up authentication protocol, during which the authentication system increases a security level of authentication measures that are required to pass prior to granting access. For example, the authentication system may trigger stepped-up authentication as part of a further access attempt to access sensitive information or to conduct a transaction.

Based on detecting possible fraudulent activity, the authentication system may step up the liveness to more advanced liveness detection tasks that may provide the authentication system with additional data points for detecting fraudulent activity and/or for authenticating the access requester as the authorized user. In other words, the authentication system may use AI to detect possible fraudulent activity, and may further use AI to perform more advanced liveness detection tasks based on possible fraudulent activity being detected. During stepped up verification, the authentication system may require the access requester to provide additional live digital evidence in the form of images, video, and/or audio for evaluation prior to granting access to an account or features within the account. For example, the authentication system may require the access requester to provide additional live digital evidence corresponding to an environment of the access requester. The authentication system may analyze the environment for determining whether or not fraudulent activity associated with the authentication event is present. The authentication system may authenticate (e.g., grant) the access attempt based on the fraudulent activity not being present, or deny the access attempt based on the fraudulent activity being present. In addition, the authentication system may, based on the fraudulent activity being present, store data, including the additional live digital evidence, for use by investigators. The authentication system may also transmit an alert to investigators of the fraudulent activity so that investigative actions can be taken against the access requester.

The authentication system may increase a number of variation types of liveness challenges, which are generated in real-time and may be tailored to the authorized user. In other words, live identity verification challenges for different access attempts may be different. The authentication system may randomize prompts indicating one or more tasks to be performed by the access requester. As a result, the authentication system may provide liveness testing that is more complex, difficult to anticipate, and more robust against fraudulent access attempts. Verbal liveness challenges may also serve as a way to authenticate an authorized user based on a stored voice biometric of the authorized user. Thus, the authentication system may provide a liveness challenge, with increased complexity by obtaining, in real-time, live digital evidence that may make the liveness challenge more difficult for a fraudster to pass.

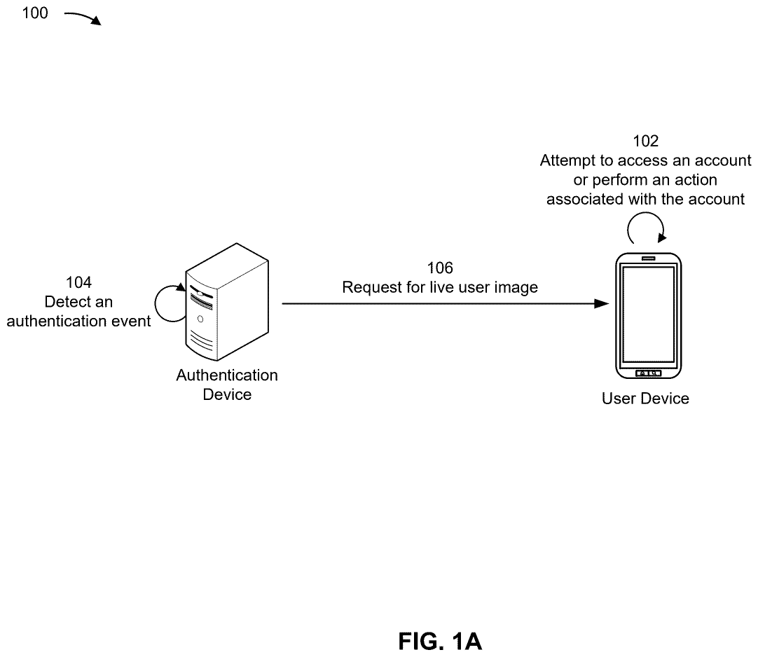

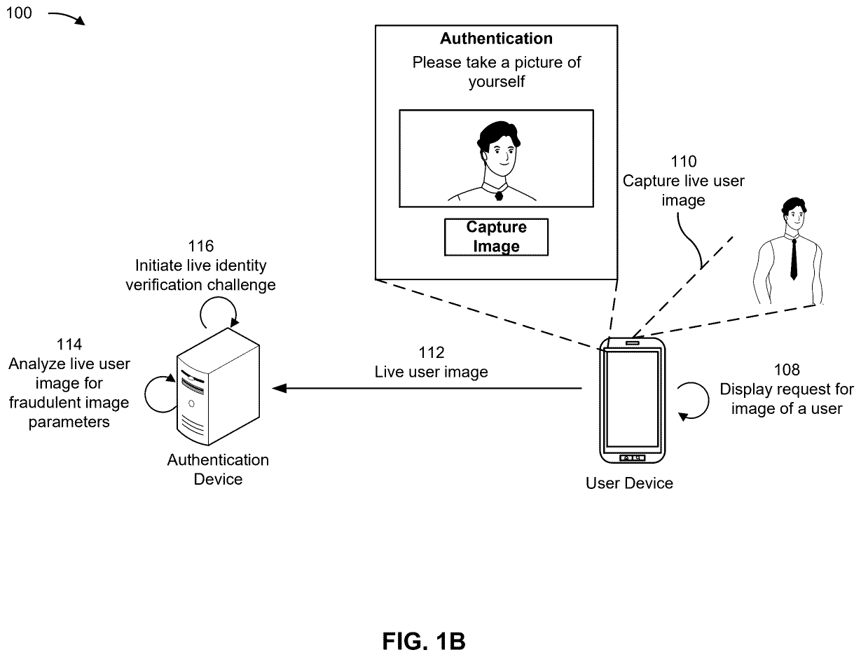

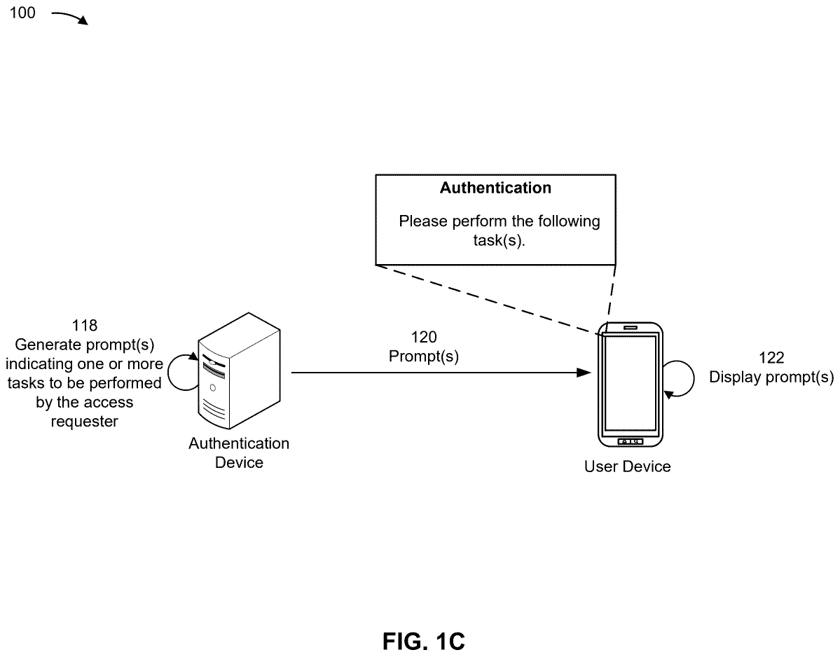

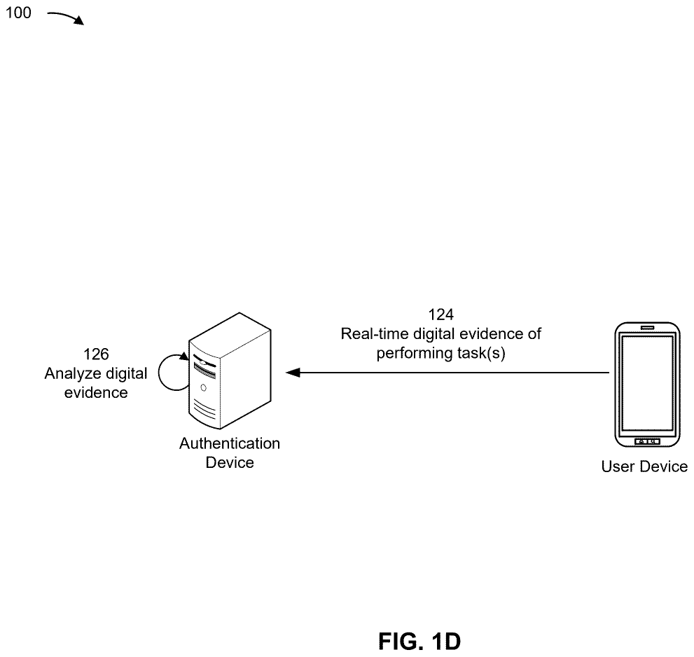

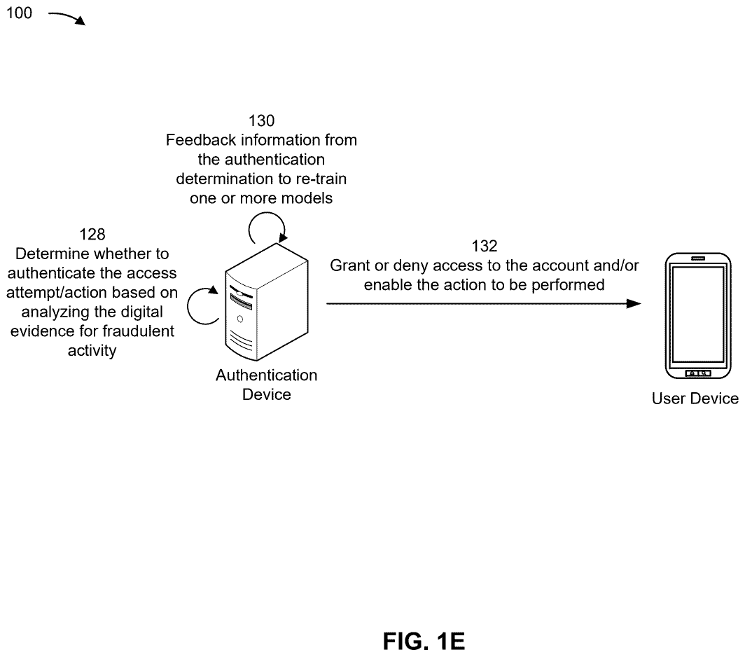

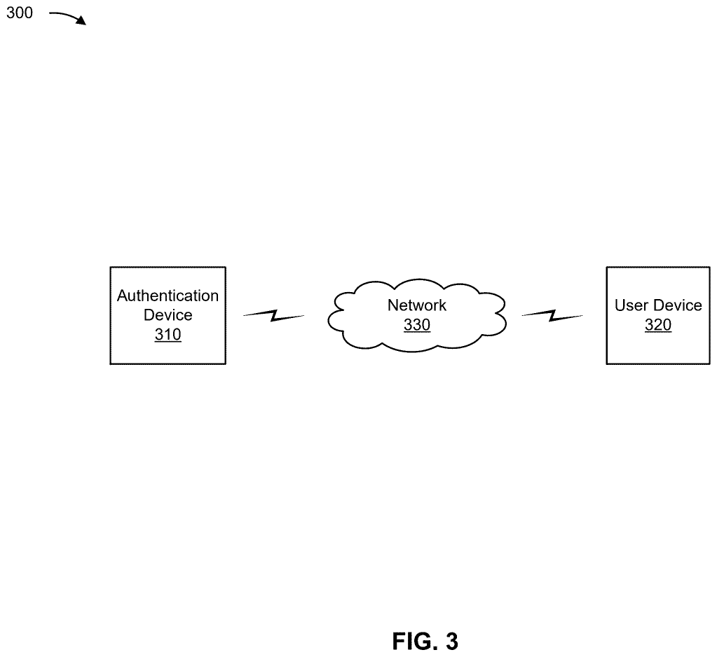

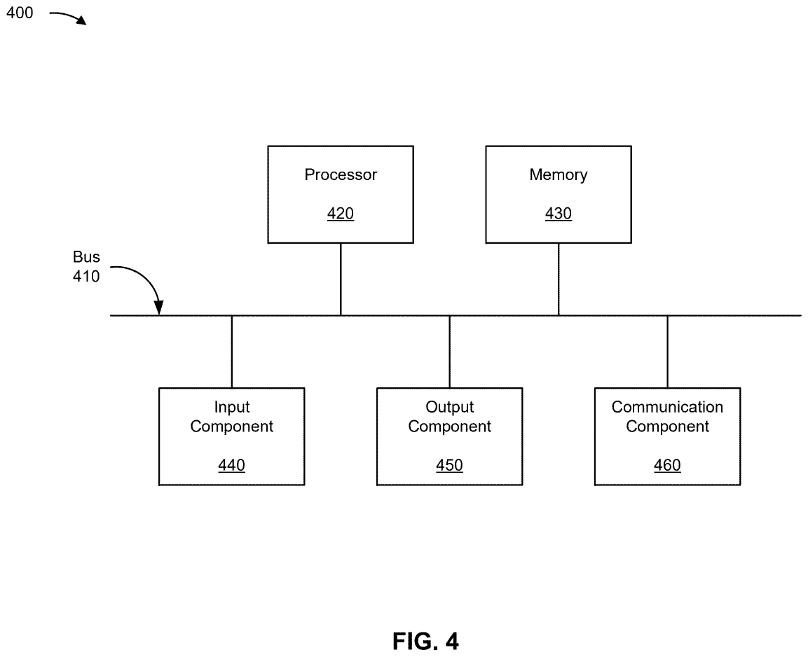

FIGS. 1A-1E are diagrams of an example 100 associated with enhanced authentication using image fraud detection during a liveness verification for determining access for a user account. As shown in FIGS. 1A-1E, example 100 includes an authentication device and a user device. These devices are described in more detail in connection with FIGS. 3 and 4.

In some implementations, the authentication device may be associated with an entity, such as an organization, a merchant, and/or a financial institution, that generates, provides, manages, and/or maintains an account (or other resource) associated with a user and/or that performs actions associated with the user. For example, the authentication device may be associated with an entity that generates, provides, manages, and/or maintains a credit card account, a loan account, a capital loan account, a checking account, a savings account, a reward account, a payment account, and/or a user account associated with the user, among other examples. As an example, the authentication device may authenticate an access attempt, performed by the user, to the account based on a confidence score satisfying a threshold, and/or the authentication device may perform an action (e.g., authorize and/or enable an action of the user to be performed) based on determining whether an access requester is an authorized user of the user account.

As shown in FIG. 1A, and by reference number 102, the user device may obtain an indication of an access attempt associated with a user account. For example, a user (e.g., an access requester) may attempt to access an account and/or may perform an action associated with the account. For example, the entity may be a credit card issuer that generates, provides, manages, and/or maintains a credit card account associated with the authorized user, and the access requester may attempt to access the credit card account by performing a login associated with the credit card account. As an example, the user device may obtain credentials, such as login credentials, via a graphical user interface (GUI) of a website associated with the credit card issuer, to perform the login associated with the credit card account.

As another example, the entity may be a merchant that operates an application that is executable on the user device of the access requester, such as a food delivery service application. For example, the merchant may generate, provide, manage, and/or maintain an account associated with the authorized user. The user device may perform the action associated with the account by obtaining a payment associated with the application account, such as by obtaining credit card information entered into a GUI of the application associated with the application account. In other words, the attempt to access the account may include a login attempt, a payment attempt, and/or an attempt to access and/or modify information associated with the account (e.g., payment information), among other examples.

As shown by reference number 104, the authentication device may detect an authentication event. In some implementations, the authentication event may be an event that the authentication device detects that triggers the authentication device to perform an authentication protocol, as described in more detail elsewhere herein. For example, the authentication event may be associated with a multi-factor authentication protocol.

In some implementations, the authentication event may be associated with the attempt to access the account performed by the access requester. As an example, if the authentication device is associated with the credit card issuer and the access requester attempts to access the credit card account by performing the login associated with the credit card account, then the authentication device may detect the login associated with the credit card account, performed by the access requester, as the authentication event.

In some implementations, the authentication event may be associated with the action associated with the account performed by the access requester. As an example, if the authentication device is associated with the merchant that operates the application and the access requester performs the payment associated with the application account, then the authentication device may detect the payment, performed by the access requester, as the authentication event. In some implementations, the authentication event may be associated with multi-factor authentication. For example, the access attempt to the account performed by the access requester may indicate valid login credentials, but the access requester may incorrectly answer a verification question. The authentication device may detect the incorrect answer provided by the access requester as the authentication event. In this example, the authentication device may request an additional authentication factor from the access requester.

As shown by reference number 106, the authentication device may transmit, and the user device may receive, a request for authentication information, such as a request for a live user image (e.g., a selfie). For example, the authentication device may transmit, and the user device may receive, the request for the authentication information based on detecting the authentication event associated with the access attempt to the account and/or an action performed in connection with the account. In some implementations, the request for the authentication information may be based on information associated with the authorized user, such as credentials. For example, the request for the authentication information may be a request for a live user image, to enable the authentication device to authenticate the access requester as the authorized user, as one authentication factor.

In some implementations, the request for the authentication information may include a request for a document image of a document. The document may be an identification document issued by a trusted entity (e.g., a government entity), such as a state driver's license, an identification card, a Territories driver's license, a tribal identification card that is signed by an associated bearer, a U.S. Military identification card that is signed by an associated bearer, a passport, a resident alien card, an employment authorization card, and/or a temporary resident card, among other examples. In some implementations, the document may be a check, a contract, a resume, a utility bill, and/or an envelope, among other examples. Thus, in some implementations, the document may include information associated with the person to which the document is issued, such as appearance information and/or information associated with an image, a current address, a signature, and/or a unique identifier associated with the person to whom the document is issued (e.g., the owner of the document), among other examples. As an example, the one or more document appearance parameters may include an age, an eye color, a gender, a skin color, a facial characteristic, a weight, and/or a height, among other examples, associated with the person to which the document is issued.

As shown in FIG. 1B, and by reference number 108, the authentication device may cause the user device to display a request for a live user image. The live user image may be a live image of the access requester. For example, the user device may display a GUI based on receiving the request for the live user image from the authentication device.

The user device may capture the live user image. In some implementations, the user may provide an input to the user device for providing the live user image. For example, the access requester may align a camera of the user device with the face of the access requester and may press a “Capture Image” button on the GUI to capture the live user image.

In some implementations, the user device may generate metadata associated with the live user image based on capturing the live user image. As an example, the metadata associated with the live user image may include geographic location information that corresponds to a location associated with the user device at a time that the live user image is captured and/or timestamp information that corresponds to a time that the live user image is captured, among other examples.

In some implementations, the geographic location information that corresponds to the location associated with the user device may be based on network connection information associated with the user device, such as wireless Internet connection information and/or mobile data connection information associated with the user device, and/or coordinate information, such as latitude and longitude coordinates associated with a geographic location obtained by a global positioning system (GPS) of the user device. As an example, the authentication device may determine one or more locations associated with the user device based on the geographic location information.

As shown by reference number 110, the user device may capture the live user image of the access requester. The live user image may be stored in a buffer memory or other memory storage accessible for transmission. The user device may prepare a communication for sending the live user image to the authentication device.

As shown by reference number 112, the authentication device may obtain, and the user device may transmit, the live user image of the access requester.

As shown by reference number 114, the authentication device may analyze, using a fraud detection machine learning model, the live user image for one or more fraudulent image parameters. The fraud detection machine learning model may include at least one of a large language model (LLM), a convolution neural network (CNN), or a multimodal AI model, with the CNN and the multimodal AI model being capable of analyzing images. The one or more fraudulent image parameters may include at least one of a deepfake image parameter, an image filter parameter, an image obfuscation parameter, a duress parameter, an unnatural image artefact, an unnatural facial feature, a distressed facial feature, an abnormal background feature, a low lighting condition, a suspicious image feature, or another image parameter indicative of possible fraudulent activity. The fraud detection machine learning model may be trained on image parameters indicative of possible fraudulent activity. Thus, the fraud detection machine learning model may be trained to recognize image parameters indicative of possible fraudulent activity. In some cases, the fraud detection machine learning model may analyze the live user image based on an image of the authorized user stored in a user database.

In some implementations, the authentication device may, using the fraud detection machine learning model, determine a confidence score based on detecting the one or more fraudulent image parameters or not detecting the one or more fraudulent image parameters. In some implementations, the authentication device may, using the fraud detection machine learning model, determine a confidence score that indicates a likelihood that the one or more fraudulent image parameters are present in the live user image, and detect the one or more fraudulent image parameters based on the confidence score satisfying a threshold.

As shown by reference number 116, the authentication device may initiate, using the fraud detection machine learning model, a live identity verification challenge based on detecting the one or more fraudulent image parameters. The authentication device may trigger the live identity verification challenge based on a stepped-up authentication protocol. In some examples, the live identity verification challenge is triggered based on the confidence score, associated with detecting or not detecting one or more fraudulent image parameters, satisfying a threshold. For example, the authentication device may initiate the live identity verification challenge based on the confidence score (e.g., a high confidence score) exceeding a threshold, with the confidence score being proportional to a likelihood that one or more fraudulent image parameters are present. Alternatively, the authentication device may evaluate the live user image for the one or more fraudulent image parameters to determine a confidence score that indicates a likelihood that the access requester is the authorized user of the user account. The authentication device may lower the confidence score based on detecting one or more suspicious factors or anomalies associated with the one or more fraudulent image parameters. For example, in the live user image, the authentication device may detect image artefacts, filters, shadows, low-lighting conditions, unnatural facial features, facial features that are inconsistent with facial features of the authorized user, and/or suspicious or abnormal metadata. Thus, the authentication device may initiate the live identity verification challenge based on the confidence score (e.g., a low confidence score) not exceeding a threshold, with the confidence score being proportional to a likelihood that the access requester is the authorized user of the user account.

As shown in FIG. 1C, and by reference number 118, the authentication device may, using the fraud detection machine learning model, generate one or more prompts indicating one or more tasks to be performed by the access requester. The one or more tasks may include providing a live full-body image of the access requester, providing a live full-body video of the access requester, providing a live environment image of an environment of the access requester, providing a live environment video of the environment of the access requester, providing a live video stream of the access requester, and/or providing a live video stream of the environment of the access requester. A prompt may specify a framing of the live user image. For example, the prompt may specify that a live user image depict at least one of a face, a body, and/or an environment of the access requester. In some cases, the prompt may instruct the access requester to take the live user image while standing outside.

The verification machine learning model may include an LLM that is configured for natural language processing tasks. The natural language processing tasks may be directed to generating one or more prompts used for verifying whether or not the access requester is the authorized user. The authentication device may instruct the access requester to obtain at least one of live image data, live video data, or live audio data while performing the one or more tasks.

As shown by reference number 120, the authentication device may execute the live identity verification challenge by prompting the access requester, with the one or more prompts, to perform the one or more tasks. For example, the authentication device may transmit, and the user device may receive, the one or more prompts. Thus, the authentication device may transmit the one or more prompts to a device associated with the access attempt. In some examples, the authentication device may sequentially transmit the one or more prompts. The authentication device may transmit subsequent prompts only if additional data points for verification are needed to authenticate the access requester.

As shown by reference number 122, the authentication device may cause the user device to display the one or more prompts on the GUI. The user device may record a performance of each task using a microphone and/or a camera.

As shown in FIG. 1D, and by reference number 124, the authentication device may obtain, from the user device, digital evidence of the access requester performing the one or more tasks. The digital evidence may include a live verbal response of the access requester, a live full-body image of the access requester, a live full-body video of the access requester, a live environment image of an environment of the access requester, and/or a live environment video of the environment of the access requester. Thus, the user device may transmit, and the authentication device may receive, the digital evidence. The digital evidence may include at least one of live image data, live video data, or live audio data.

As shown by reference number 126, the authentication device may analyze, using the verification machine learning model, the digital evidence to determine whether or not fraudulent activity associated with the authentication event is present. The authentication device may analyze the digital evidence to determine a confidence score that indicates a likelihood that the access requester is the authorized user of the user account. The authentication device may authenticate the access attempt based on the confidence score satisfying a threshold.

In some implementations, one or more tasks may include providing a verbal response, and the digital evidence may include a voice recording of the verbal response. The authentication device may use the verification machine learning model to compare the voice recording to a voice biometric template of an authorized user of the user account to determine a confidence score that indicates a likelihood that the voice recording of the access requester is associated with the authorized user. In addition, the authentication device may determine that fraudulent activity associated with the authentication event is not present based on the confidence score satisfying a threshold, or determine that fraudulent activity associated with the authentication event is present based on the confidence score not satisfying the threshold.

In some examples, the authentication device may store the voice recording of the access requester in one or more memories based on determining that fraudulent activity associated with the authentication event is present. The voice recording may be used to detect other fraudulent attempts made by the access requester. In other words, the voice recording may be used by the authentication device during future access attempts made on the same or different user accounts to improve an accuracy of detecting other fraudulent attempts made by the access requester. Thus, the authentication device may build a profile associated with the access requester (e.g., a suspected fraudster) to facilitate detecting other fraudulent attempts made by the access requester. For example, the authentication device may compare a voice recording associated with a different authentication event with the voice recording of the access requester to determine whether the voice recording associated with the different authentication event is associated with the voice recording of the access requester. Additionally, the authentication device may detect fraudulent activity associated with the different authentication event based on the voice recording associated with the different authentication event being associated with the voice recording of the access requester. For example, the authentication device may detect fraudulent activity associated with the different authentication event based on matching voice patterns in the two voice recordings.

In some implementations, the authentication device may evaluate the digital evidence (e.g., a voice recording of a verbal response) to determine whether the access requester is under duress. For example, the access requester may be the authorized user. However, the authorized user may be attempting to access the user account while under duress, which may cause abnormal fluctuations in the authorized user's voice. The authentication device may compare the voice recording to a voice biometric template of the authorized user to determine a confidence score that indicates a likelihood that the access requester is under duress. The authentication device may determine that fraudulent activity associated with the authentication event is not present based on the confidence score satisfying a threshold, or determine that fraudulent activity associated with the authentication event is present based on the confidence score not satisfying the threshold.

In some implementations, one or more tasks may include providing a live full-body image of the access requester. Thus, the digital evidence may include the live full-body image. The authentication device may, using the fraud detection machine learning model, analyze the live full-body image to estimate one or more biometric parameters of the access requester, such as weight and/or height. The authentication device may compare the one or more biometric parameters of the access requester with one or more known biometric parameters of the authorized user to determine a confidence score that indicates a likelihood that the access requester is the authorized user. The authentication device may determine that fraudulent activity associated with the authentication event is not present based on the confidence score satisfying a threshold, or may determine that fraudulent activity associated with the authentication event is present based on the confidence score not satisfying the threshold.

In some implementations, one or more tasks may include providing a live video of the access requester while the access requester performs a 360-degree spin. Thus, the digital evidence may include the live video. The authentication device may, using the fraud detection machine learning model, analyze the live video for one or more fraud indicators to determine a confidence score that indicates a likelihood that fraudulent activity associated with the authentication event is present. The authentication device may detect that fraudulent activity associated with the authentication event is present based on the confidence score satisfying a threshold.

In some implementations, the authentication device may, using the fraud detection machine learning model, analyze an environment of the access requester for one or more fraud indicators to determine a confidence score that indicates a likelihood that the fraudulent activity associated with the authentication event is present. For example, the authentication device may prompt the access requester to obtain a live image or a live video of the environment. Alternatively, the authentication device may evaluate the environment visible in a live full-body image or in a video taken while the access requester performs a 360-degree spin. The authentication device may detect that the fraudulent activity associated with the authentication event is present based on the confidence score satisfying a threshold.

As shown in FIG. 1E, and by reference number 128, the authentication device may determine whether to authenticate the access attempt and/or action based on analyzing the digital evidence for fraudulent activity, as described in more detail elsewhere herein. The authentication device may authenticate the access attempt and/or action based on the access requester being verified as the authorized user of the user account.

In some implementations, the authentication device may determine whether one or more confidence scores satisfy one or more thresholds, as described in more detail elsewhere herein. In some implementations, the one or more thresholds may include a first threshold and a second threshold. As an example, if the confidence score is greater than a first threshold, then the authentication device may determine that the confidence score satisfies the first threshold. As another example, if the confidence score is less than the first threshold and greater than the second threshold, then the authentication device may determine that the confidence score does not satisfy the first threshold and does satisfy the second threshold. In some implementations, the authentication device may determine whether to authenticate the access attempt to the account and/or perform the action based on the one or more confidence scores satisfying a respective threshold (e.g., the first threshold or the second threshold).

In some implementations, the authentication device may determine whether the confidence score satisfies the threshold as one factor (e.g., of multiple factors) in determining whether to authenticate the access attempt to the account and/or perform the action. As an example, the authentication device may determine that the confidence score satisfies the threshold and may input that information into a machine learning model for further authentication analysis. For example, if the authentication device determines that a confidence score for a verbal response satisfies a second threshold, but not a first threshold, the access requester may still be authenticated based on performing additional tasks, as described in more detail elsewhere herein.

As shown by reference number 130, the authentication device may obtain feedback information from the authentication determination to re-train one or more models. In some implementations, the authentication device may provide feedback, to a prediction model, that indicates that the digital evidence is associated with the authorized user. In some implementations, providing the feedback, such as prompts used during a live identity verification challenge, and corresponding authentication decisions to the machine learning model, may improve the machine learning model. For example, providing the feedback to the machine learning model may improve the accuracy of the machine learning model and/or may improve feature selection associated with the machine learning model.

As shown by reference number 132, the authentication device may grant or deny access to the account and/or enable the action to be performed. In some implementations, the authentication device may grant or deny access to the account and/or may enable the action to be performed based on one or more confidence scores satisfying one or more thresholds. As an example, the authentication device may authenticate the access attempt based on a confidence score satisfying a threshold. As another example, the authentication device may refrain from authenticating the access attempt to the account, and/or refrain from performing the action, based on determining that the confidence score does not satisfy the threshold. If the confidence score does not satisfy the second threshold, then the authentication device may deny access, may refrain from enabling the action to be performed, and/or may perform a higher level of authentication operations by way of performance of additional tasks. For example, the authentication device may request a live user image that provides more context information associated with the environment of the access requester. In some implementations, the authentication device may use a multi-factor approach to determine whether to authenticate the access attempt to the account and/or perform the action (e.g., the authentication device may use one or more factors and/or one or more machine learning models).

In some implementations, the authentication device may use an authentication model to determine whether the access attempt is authentic based on a confidence score. As an example, the authentication device may provide the confidence score as an input to an authentication model. The authentication model may generate an output that indicates whether the access attempt is authentic. The authentication device may authenticate the access attempt based on an output of the authentication model indicating that the access attempt is authentic. In some implementations, the authentication device may store the digital evidence based on the confidence score satisfying the threshold and authenticate one or more future access attempts for the account using the digital evidence. In this way, because the digital evidence is more recent, the digital evidence may provide a more accurate comparison point for the future authentication.

In some implementations, the authentication device may store a device location indicated by geographic location information based on the confidence score satisfying the threshold, and may authenticate one or more future access attempts for the account using the device location. In this way, the device location may be stored as a trusted device location, and may streamline future access attempts based on the trusted device location.

In some implementations, the authentication device may obtain, from the authentication model, one or more estimated device location regions and respective confidence scores based on a device location indicated by the geographic location information. In some implementations, the authentication device may determine the confidence score based on the address information, the geographic location information, and the estimated device location regions and the respective confidence scores.

In this way, some implementations described herein provide enhanced user authentication using image fraud detection during a liveness verification. Because the authentication device uses enhanced authentication techniques using a live identity verification challenge with live digital evidence, the authentication device may consume fewer resources as compared to other authentication techniques (e.g., by avoiding a need to perform actions associated with incorrect authentication determinations, such as forensic examination of data, generating notifications, and/or transmitting the notifications).

In some implementations, the authentication device may transmit fraud alert information, corresponding to detected fraudulent activity, to one or more investigator networks.

As indicated above, FIGS. 1A-1E are provided as an example. Other examples may differ from what is described with regard to FIGS. 1A-1E.

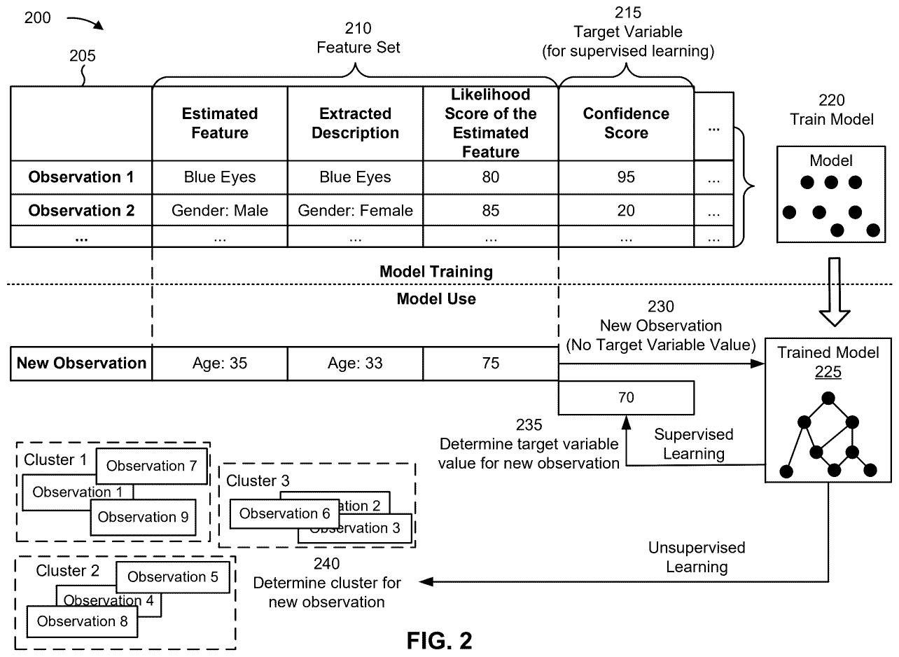

FIG. 2 is a diagram illustrating an example 200 of training and using a machine learning model in connection with enhanced authentication using image fraud detection during a liveness verification. The machine learning model training and usage described herein may be performed using a machine learning system. The machine learning system may include or may be included in a computing device, a server, a cloud computing environment, or the like, such as the authentication device described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the authentication device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the authentication device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of estimated feature, a second feature of extracted description, a third feature of likelihood score of the estimated feature, and so on. As shown, for a first observation, the first feature may have a value of blue eyes, the second feature may have a value of blue eyes, the third feature may have a value of 80, and so on. These features and feature values are provided as examples, and may differ in other examples. For example, the feature set may include one or more of the following features: appearance parameters, such as an age, an eye color, a gender, a skin color, a facial characteristic, a weight, and/or a height, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is confidence score, which has a value of 95 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical data associated with one or more appearance parameters, such as one or more appearance parameters associated with an image that depicts a face of a person.

As shown by reference number 230, the machine learning system may apply the trained machine learning model 225 to a new observation, such as by receiving a new observation and inputting the new observation to the trained machine learning model 225. As shown, the new observation may include a first feature of estimated feature, a second feature of extracted description, a third feature of likelihood score of the estimated feature, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 70 for the target variable of confidence score for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation that the authentication device authenticates the access attempt and/or a recommendation that the authentication device performs the action. The first automated action may include, for example, causing the authentication device to authenticate the access attempt and/or causing the authentication device to perform the action.

As another example, if the machine learning system were to predict a value of 20 for the target variable of confidence score, then the machine learning system may provide a second (e.g., different) recommendation (e.g., a recommendation that the authentication device does not authenticate the access attempt and/or a recommendation that the authentication device does not perform the action) and/or may perform or cause performance of a second (e.g., different) automated action (e.g., causing the authentication device to generate an alert).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., definitely authenticate), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., maybe authenticate), then the machine learning system may provide a second (e.g., different) recommendation (e.g., a recommendation that the authentication device requests additional authentication information from the user) and/or may perform or cause performance of a second (e.g., different) automated action, such as causing the authentication device to request additional authentication information from the user.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. In some implementations, the machine learning model may be based on a liveness testing model. For example, the liveness testing model may determine one or more tasks suitable for a live identity verification challenge, generate prompts for the one or more tasks, analyze digital evidence associated with a performance of the one or more tasks to verify whether the access requester is the authorized user of the user account, and/or generate an output that indicates whether an access attempt is authentic, as described in more detail elsewhere herein. In this example, the machine learning model may determine the confidence score based on the digital evidence.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). Providing the feedback to the machine learning model may improve the accuracy of the machine learning model and/or may improve feature selection associated with the machine learning model.

In this way, the machine learning system may apply a rigorous and automated process to enhanced authentication using image fraud detection during a liveness verification. The machine learning system may enable recognition and/or identification of tens, hundreds, thousands, or millions of features and/or feature values for tens, hundreds, thousands, or millions of observations, thereby increasing accuracy and consistency and reducing delay associated with enhanced authentication using image fraud detection during a liveness verification, relative to requiring computing resources to be allocated for tens, hundreds, or thousands of operators to manually authenticate access attempts and/or perform actions using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an authentication device 310, a user device 320, and/or a network 330. Devices of environment 300 may interconnect via wired connections, wireless connections, or a combination of wired and wireless connections.

The authentication device 310 may include one or more devices capable of receiving, generating, storing, processing, providing, and/or routing information associated with enhanced authentication using image fraud detection during a liveness verification, as described elsewhere herein. The authentication device 310 may include a communication device and/or a computing device. For example, the authentication device 310 may include a server, such as an application server, a client server, a web server, a database server, a host server, a proxy server, a virtual server (e.g., executing on computing hardware), or a server in a cloud computing system. In some implementations, the authentication device 310 may include computing hardware used in a cloud computing environment.

The user device 320 may include one or more devices capable of receiving, generating, storing, processing, and/or providing information associated with enhanced authentication using image fraud detection during a liveness verification, as described elsewhere herein. The user device 320 may include a communication device and/or a computing device. For example, the user device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 330 may include one or more wired and/or wireless networks. For example, the network 330 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 330 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with enhanced authentication using image fraud detection during a liveness verification. The device 400 may correspond to the authentication device 310 and/or the user device 320. In some implementations, the authentication device 310 and/or the user device 320 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

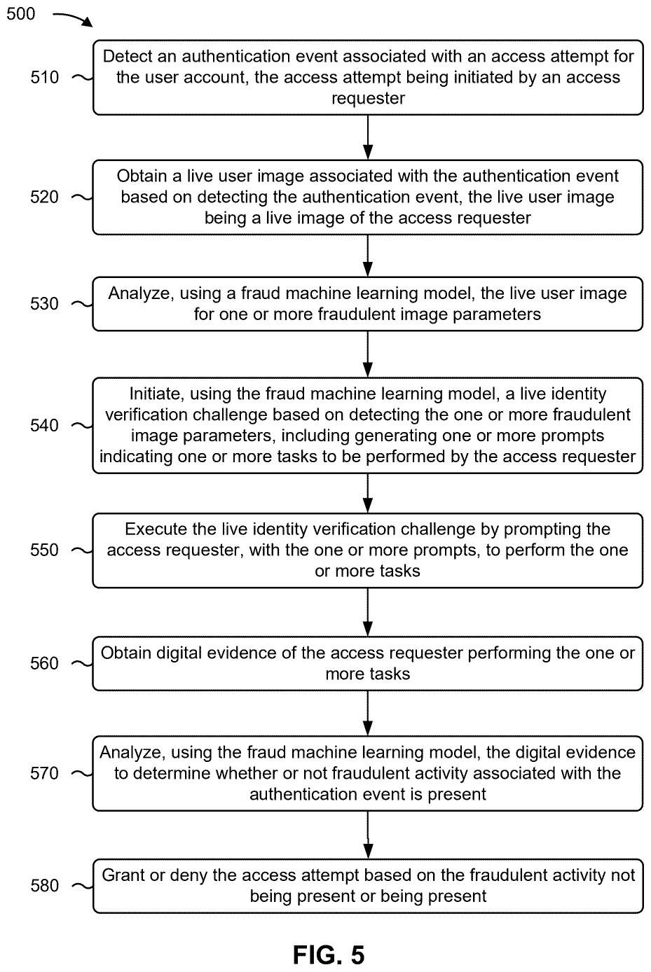

FIG. 5 is a flowchart of an example process 500 associated with enhanced authentication using image fraud detection during a liveness verification. In some implementations, one or more process blocks of FIG. 5 may be performed by the authentication device 310. In some implementations, one or more process blocks of FIG. 5 may be performed by another device or a group of devices separate from or including the authentication device 310, such as the user device 320. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include detecting an authentication event associated with an access attempt for the user account, the access attempt being initiated by an access requester (block 510). For example, the authentication device 310 (e.g., using processor 420 and/or memory 430) may detect an authentication event associated with an access attempt for the user account, as described above in connection with reference number 104 of FIG. 1A.

As further shown in FIG. 5, process 500 may include obtaining a live user image associated with the authentication event based on detecting the authentication event, the live user image being a live image of the access requester (block 520). For example, the authentication device 310 (e.g., using processor 420 and/or memory 430) may obtain a live user image associated with the authentication event based on detecting the authentication event, the live user image being a live image of the access requester, as described above in connection with reference number 112 of FIG. 1B.

As further shown in FIG. 5, process 500 may include analyzing, using a fraud detection machine learning model, the live user image for one or more fraudulent image parameters (block 530). For example, the authentication device 310 (e.g., using processor 420 and/or memory 430) may analyze, using the fraud detection machine learning model, the live user image for one or more fraudulent image parameters, as described above in connection with reference number 114 of FIG. 1B.

As further shown in FIG. 5, process 500 may include initiating, using the fraud detection machine learning model, a live identity verification challenge based on detecting the one or more fraudulent image parameters, including generating one or more prompts indicating one or more tasks to be performed by the access requester (block 540). For example, the authentication device 310 (e.g., using processor 420 and/or memory 430) may initiate, using the fraud detection machine learning model, a live identity verification challenge based on detecting the one or more fraudulent image parameters, as described above in connection with reference number 116 of FIG. 1B.

As further shown in FIG. 5, process 500 may include executing the live identity verification challenge by prompting the access requester, with the one or more prompts, to perform the one or more tasks (block 550). For example, the authentication device 310 (e.g., using processor 420 and/or memory 430) may execute the live identity verification challenge by prompting the access requester, with the one or more prompts, to perform the one or more tasks, as described above in connection with reference numbers 118 and 120 of FIG. 1C.

As further shown in FIG. 5, process 500 may include obtaining digital evidence of the access requester performing the one or more tasks, the digital evidence including at least one of live image data, live video data, or live audio data (block 560). For example, the authentication device 310 (e.g., using processor 420 and/or memory 430) may obtain digital evidence of the access requester performing the one or more tasks, as described above in connection with reference number 124 of FIG. 1D.

As further shown in FIG. 5, process 500 may include analyzing, using the fraud detection machine learning model, the digital evidence to determine whether or not fraudulent activity associated with the authentication event is present (block 570). For example, the authentication device 310 (e.g., using processor 420 and/or memory 430) may analyze, using the fraud detection machine learning model, the digital evidence to determine whether or not fraudulent activity associated with the authentication event is present, as described above in connection with reference number 126 of FIG. 1D.

As further shown in FIG. 5, process 500 may include granting, by the verification system, the access attempt based on the fraudulent activity not being present, or denying, by the verification system, the access attempt based on the fraudulent activity being present (block 580). For example, the authentication device 310 (e.g., using processor 420 and/or memory 430) may grant the access attempt based on the fraudulent activity not being present, or deny the access attempt based on the fraudulent activity being present, as described above in connection with reference number 128 and 132 of FIG. 1E.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for enhanced user authentication using image fraud detection during a liveness verification for determining access for a user account, the system comprising:
one or more memories; and
one or more processors, communicatively coupled to the one or more memories, configured to:
detect an authentication event associated with an access attempt for the user account, the access attempt being initiated by an access requester;
obtain a live user image associated with the authentication event based on detecting the authentication event, the live user image being a live image of the access requester;
analyze, using a fraud detection machine learning model, the live user image for one or more fraudulent image parameters;
initiate, using the fraud detection machine learning model, a live identity verification challenge based on detecting the one or more fraudulent image parameters, including generating one or more prompts indicating one or more tasks to be performed by the access requester;
execute the live identity verification challenge by prompting the access requester, with the one or more prompts, to perform the one or more tasks;
obtain digital evidence of the access requester performing the one or more tasks, wherein the digital evidence includes at least one of live image data, live video data, or live audio data;
analyze, using the fraud detection machine learning model, the digital evidence to determine whether or not fraudulent activity associated with the authentication event is present; and
authenticate the access attempt based on the fraudulent activity not being present; or
deny the access attempt based on the fraudulent activity being present.

2. The system of claim 1, wherein the fraud detection machine learning model includes at least one of a large language model (LLM), a convolution neural network (CNN), or a multimodal artificial intelligence (AI) model.

3. The system of claim 1, wherein the live user image depicts a face of the access requester.

4. The system of claim 1, wherein the one or more fraudulent image parameters include at least one of a deepfake image parameter, an image filter parameter, an image obfuscation parameter, a duress parameter, an unnatural image artefact, an unnatural facial feature, a distressed facial feature, an abnormal background feature, or a low lighting condition.

5. The system of claim 1, wherein the one or more processors, to analyze the live user image for the one or more fraudulent image parameters, are configured to:
determine a confidence score based on detecting the one or more fraudulent image parameters or not detecting the one or more fraudulent image parameters, and
wherein the one or more processors, to initiate the live identity verification challenge, are configured to:
trigger the live identity verification challenge based on the confidence score satisfying a threshold.

6. The system of claim 1, wherein the one or more processors, to analyze the live user image for the one or more fraudulent image parameters, are configured to:
determine a confidence score that indicates a likelihood that the one or more fraudulent image parameters are present in the live user image; and
detect the one or more fraudulent image parameters based on the confidence score satisfying a threshold.

7. The system of claim 1, wherein the one or more tasks include providing a verbal response,
wherein the digital evidence includes a voice recording of the verbal response, and
wherein the one or more processors, to analyze the digital evidence, are configured to:
compare the voice recording to a voice biometric template of an authorized user of the user account to determine a confidence score that indicates a likelihood that the voice recording of the access requester is associated with the authorized user, and
determine that the fraudulent activity associated with the authentication event is not present based on the confidence score satisfying a threshold, or
determine that the fraudulent activity associated with the authentication event is present based on the confidence score not satisfying the threshold.

8. The system of claim 7, wherein the one or more processors are further configured to:
store the voice recording of the access requester in one or more memories based on determining that the fraudulent activity associated with the authentication event is present;
compare a voice recording associated with a different authentication event with the voice recording of the access requester to determine whether the voice recording associated the different authentication event is associated with the voice recording of the access requester; and
detect fraudulent activity associated with the different authentication event based on the voice recording associated with the different authentication event being associated with the voice recording of the access requester.

9. The system of claim 1, wherein the one or more tasks include providing a verbal response,
wherein the digital evidence includes a voice recording of the verbal response, and
wherein the one or more processors, to analyze the digital evidence, are configured to:
compare the voice recording to a voice biometric template of an authorized user of the user account to determine a confidence score that indicates a likelihood that the access requester is under duress, and
determine that the fraudulent activity associated with the authentication event is not present based on the confidence score satisfying a threshold, or
determine that the fraudulent activity associated with the authentication event is present based on the confidence score not satisfying the threshold.

10. The system of claim 1, wherein the one or more tasks include at least one of providing a live full-body image of the access requester, providing a live full-body video of the access requester, providing a live environment image of an environment of the access requester, providing a live environment video of the environment of the access requester, providing a live video stream of the access requester, or providing a live video stream of the environment of the access requester.

11. The system of claim 1, wherein the digital evidence includes at least one of:
a live verbal response of the access requester,
a live full-body image of the access requester,
a live full-body video of the access requester,
a live environment image of an environment of the access requester, or
a live environment video of the environment of the access requester.

12. The system of claim 1, wherein the one or more tasks include providing a live full-body image of the access requester,
wherein the digital evidence includes the live full-body image, and
wherein the one or more processors, to analyze the digital evidence, are configured to:
analyze the live full-body image to estimate one or more biometric parameters of the access requester;
compare the one or more biometric parameters of the access requester with one or more known biometric parameters of an authorized user of the user account to determine a confidence score that indicates a likelihood that the access requester is the authorized user; and
determine that the fraudulent activity associated with the authentication event is not present based on the confidence score satisfying a threshold; or
determine that the fraudulent activity associated with the authentication event is present based on the confidence score not satisfying the threshold.

13. The system of claim 12, wherein the one or more biometric parameters include at least one of a weight or a height.

14. The system of claim 1, wherein the one or more tasks include providing a live video of the access requester while the access requester performs a 360-degree spin,
wherein the digital evidence includes the live video, and
wherein the one or more processors, to analyze the digital evidence, are configured to:
analyze the live video for one or more fraud indicators to determine a confidence score that indicates a likelihood that the fraudulent activity associated with the authentication event is present; and
detect that the fraudulent activity associated with the authentication event is present based on the confidence score satisfying a threshold.

15. The system of claim 1, wherein the one or more processors, to analyze the digital evidence, are configured to:
analyze, using the fraud detection machine learning model, an environment of the access requester for one or more fraud indicators to determine a confidence score that indicates a likelihood that the fraudulent activity associated with the authentication event is present; and
detect that the fraudulent activity associated with the authentication event is present based on the confidence score satisfying a threshold.

16. The system of claim 6, wherein the one or more processors are further configured to transmit fraud alert information, corresponding to the fraudulent activity, to one or more investigator networks.

17. A system for enhanced user authentication using image fraud detection during a liveness verification for determining access for a user account, the system comprising:
one or more memories; and
one or more processors, communicatively coupled to the one or more memories, configured to:
detect an authentication event associated with an access attempt for the user account, the access attempt being initiated by an access requester;
obtain a live user image associated with the authentication event based on detecting the authentication event, the live user image being a live image of the access requester;
analyze, using a fraud detection machine learning model, the live user image for one or more fraudulent image parameters;
execute, using the fraud detection machine learning model, a liveness challenge based on detecting the one or more fraudulent image parameters to determine whether or not fraudulent activity associated with the authentication event is present; and
authenticate the access attempt based on the fraudulent activity not being present; or
deny the access attempt based on the fraudulent activity being present.

18. A method for performing image fraud detection during a liveness verification for determining access for a user account, comprising:
detecting, by a verification system, an authentication event associated with an access attempt for the user account, the access attempt being initiated by an access requester;
obtaining, by the verification system, a live user image associated with the authentication event based on detecting the authentication event, the live user image being a live image of the access requester;
analyzing, by the verification system, using a fraud detection machine learning model, the live user image for one or more fraudulent image parameters;
initiating, by the verification system, using the fraud detection machine learning model, a live identity verification challenge based on detecting the one or more fraudulent image parameters, including generating one or more prompts indicating one or more tasks to be performed by the access requester;
executing, by the verification system, the live identity verification challenge by prompting the access requester, with the one or more prompts, to perform the one or more tasks;
obtaining, by the verification system, digital evidence of the access requester performing the one or more tasks, wherein the digital evidence includes at least one of live image data, live video data, or live audio data;
analyzing, by the verification system, using the fraud detection machine learning model, the digital evidence to determine whether or not fraudulent activity associated with the authentication event is present; and
authenticating, by the verification system, the access attempt based on the fraudulent activity not being present; or
denying, by the verification system, the access attempt based on the fraudulent activity being present.

19. The method of claim 18, wherein analyzing the live user image for the one or more fraudulent image parameters comprises:
determining a confidence score based on detecting the one or more fraudulent image parameters or not detecting the one or more fraudulent image parameters, and wherein initiating the live identity verification challenge comprises:
triggering the live identity verification challenge based on the confidence score satisfying a threshold.

20. The method of claim 18, wherein the digital evidence includes the live image data or the live video data, and
wherein analyzing the digital evidence comprises:
analyzing the live image data or the live video data for one or more fraud indicators to determine a confidence score that indicates a likelihood that the fraudulent activity associated with the authentication event is present; and
detecting that the fraudulent activity associated with the authentication event is present based on the confidence score satisfying a threshold.
